(19) United States
(12) Patent Application Publication
(10) Pub. No.: US 2002/0080240 A1
(43) Pub. Date: Jun. 27, 2002

(54) Television camera apparatus

(76) Inventor: Eiichi Omi, Tokyo (JP)

Correspondence Address: JACOBSON HOLMAN PLLC, 400 SEVENTH STREET N.W., SUITE 600, WASHINGTON, DC, 20004, US

(21) Appl. No.: 09/809,258

(22) Filed: Mar. 16, 2001

(30) Foreign Application Priority Data
Dec. 27, 2000 (JP) 2000-396514

(51) Int. Cl. H04N 5/225

(52) U.S. Cl. 348/207

(57) ABSTRACT

The present invention is directed to providing a televising camera apparatus in which its microscopic unit and observing unit or a monitor unit are not connected to each other by cable, and this eliminates restrictions of a relative position of the microscopic unit to the monitor unit, so as to facilitate indoor observation of samples such as snow as they would be in their respective natural environments. The present invention is also directed to providing a televising camera apparatus of a simple configuration which allows an observer to see samples from desired positions without a rotating sample-mounting plate when the samples assume an orientation varied from one side to another as in a minute identification mark labeled for discriminating authenticated paper currencies and securities from counterfeit ones because of its inconspicuous and incomprehensible geometrical characteristic when seen from only a single fixed position. The televising camera apparatus is provided with a base, a supporting arm pivotally fixed about a rotation axis orthogonal to the base, a sample-mounting plate, microscopic object optics, and illuminating optics attached respectively to the supporting arm, and a wireless televising camera unit located in an imaging position in the microscopic object optics.

### FIELD OF THE INVENTION

The present invention relates to a televising camera apparatus such as a televising microscope and a television microscopic system, and more particularly, it relates to a televising camera apparatus, such as a televising microscope and a televising microscope system, which can allow an observer to remotely monitor non-invertible samples including objects floating in liquid from any desired position such as the one under the objects, and/or which has a camera unit and a display unit positioned far away from each other in wireless communication with each other so as to eliminate annoying manipulation of those units.

### PRIOR ART

In general, prior art ordinary microscopes have oculars, and this causes freedom of monitoring posture to be limited, which also causes observable phases of monitored samples to be highly restricted.

To overcome such a disadvantage, there have been commercially available cable televising microscopes in which a reflective illuminating optics, an objective optics, and a cable televising camera have all been integrated into a single unit and detachably mounted onto a base.

Such prior art cable televising microscopes have been inconvenient in that a microscopic unit and an observing unit or a monitor unit are connected with each other by cable, and this restricts relative positions of the microscopic unit to the monitor unit. For observation of snow that must be conducted in the open air to monitor snow as it naturally falls, it sometimes might be preferable to conduct indoor observation if time-consuming task is expected, but various factors prohibit the indoor observation from being performed.

Another disadvantage of the prior art is that it is difficult to observe samples from desired positions when the samples assume orientations varied from one side to another as in a minute identification mark labeled for discriminating authenticated paper currencies and securities from counterfeit ones because of its inconspicuous and incomprehensible geometrical profile when seen from only a single fixed position. An optical system such as a polarizing microscope has its sample-mounting plate configured to be pivotal about an optical axis although such pivotal movement is restricted precisely to rotations in a single plane, and the configuration required to be of high precisions causes the system to be expensive and to fail to have portability for observation anywhere convenient and desired.

Further disadvantage of the above-mentioned cable televising microscope is that it is fixedly supported by a supporting base and assumes a fixed posture oriented downward to observe the sample-mounting plate down under. However, it is essential observing samples such as aquatic animals as they would be in their respective natural aquatic environments, and it is also sometimes desirable observing phases of the samples seen from varied positions, especially observing their bottoms. In such a case, the samples should be contained in a vessel having a clear and transparent bottom for observation from a position under the vessel, but this is practically impossible in the prior art cable televising microscopes.

Moreover, in the prior art, no such device has been developed as the one that has a telescopic camera unit and a display unit incorporated mechanically separate from each other to locate the units separately in varied positions as desired. It is just as in an astronomical telescope where an objective optics and an ocular optics are integral with each other, so that an observer himself or herself must stay in the darkness even in cold or chilling atmosphere to speculate celestial bodies under the conditions of desired surrounding brightness and dust in the air.

The present invention is an improvement that overcomes such disadvantages and inconveniences of the prior art cable televising microscopes, and accordingly, it is an object of the present invention to provide a televising microscope that has a microscope unit and an observing unit or a monitor unit are not connected with each other by cable, so that there is no restriction imposed upon relative positions between the microscope unit and the monitor unit so as to facilitate indoor observation of snow in its natural environment and observation of any other object in their respective natural environments in any convenient site.

It is another object of the present invention to provide a televising microscope which allows an observer to see samples from desired positions without using a pivotal sample-mounting plate when the samples assume orientations varied from one side to another as in a minute identification mark labeled for discriminating authenticated paper currencies and securities from counterfeit ones because of its inconspicuous and incomprehensible geometrical profile when seen from only a single fixed position.

It is still another object of the present invention to provide a televising microscope which allows an observer to see samples such as aquatic animals from a position under the samples as they would be in natural aquatic environments.

It is further another object of the present invention to provide a televising camera apparatus as used in an astronomical telescope which has a televising camera unit substituted for an ocular optics to produce photoelectrically converted image signals in conditions of desired surrounding brightness and dust in the air, so as to allow an observer in a laboratory or a lecture room to see images on a display device therein.

### SUMMARY OF THE INVENTION

In accordance with the present invention, a televising microscope is comprised of a base, a supporting arm pivotally fixed about a rotation axis approximately orthogonal to the base, a sample-mounting plate, microscopic object optics, and illuminating optics plate attached respectively to the supporting arm, and a wireless televising camera unit located in an imaging position in the microscopic object optics.

In another aspect of the present invention, a televising microscope is comprised of a base, a supporting arm pivotally fixed about a rotation axis approximately orthogonal to the base, a sample-mounting plate attached to the base, microscopic object optics and illuminating optics attached respectively to the supporting arm, and a wireless televising camera unit located in an imaging position in the microscopic object optics.

In further another aspect of the present invention, a televising microscope is comprised of a base, a supporting arm pivotally fixed about a rotation axis orthogonal to the base, a sample-mounting plate, microscopic object optics, and illuminating optics attached respectively to the supporting arm, a wireless televising camera unit located in an imaging position in the microscopic object optics, and a display device.

In still another aspect of the present invention, a televising microscope system is comprised of a base, a supporting arm pivotally fixed about a rotation axis orthogonal to the base, a sample-mounting plate attached to the base, microscopic object optics and illuminating optics attached respectively to the supporting arm, a wireless televising camera unit located in an imaging position in the microscopic object optics, and a display device.

In another aspect of the present invention, a televising camera apparatus is comprised of an object lens barrel holding an object lens, a camera housing detachably fixed to the object lens barrel, a light receiving element located in an imaging position in relation with the object lens within the camera housing, a television radio generator converting and transmitting wireless image signals produced by the light receiving element, and a display device receiving the image signals from the televising radio generator and representing images.

Embodiments according to the present invention include improved features as follows:

The base can be altered in relative position to the rotation axis so as to be horizontal and non-horizontal.

When the supporting arm rotates about the rotation axis, the sample-mounting plate does not rotate while the microscopic object optics and the illuminating optics rotate along with the supporting arm.

The televising microscope has ocular optics substituted for the wireless televising camera unit.

The wireless televising camera unit has a CMOS image sensor.

The wireless televising camera unit has a CCD image sensor.

### BRIEF DESCRIPTION OF THE DRAWINGS

FIG. 1 is a perspective view showing an embodiment of a televising microscope according to the present invention;

FIG. 2 is a perspective view illustrating microscopic object optics in the embodiment of the televising microscope according to the present invention;

FIG. 3 is a perspective view illustrating a wireless televising camera unit of the embodiment of the televising microscope according to the present invention;

FIG. 4 is a front view showing the embodiment of the televising microscope according to the present invention, with the televising microscope assuming a posture for horizontal observation;

FIG. 5 is a front view showing the embodiment of the televising microscope according to the present invention, with the televising microscope assuming a posture for vertical observation from the bottom of a sample;

FIG. 6 is a diagram illustrating an exemplary arrangement of a televising microscopic system according to the present invention; and

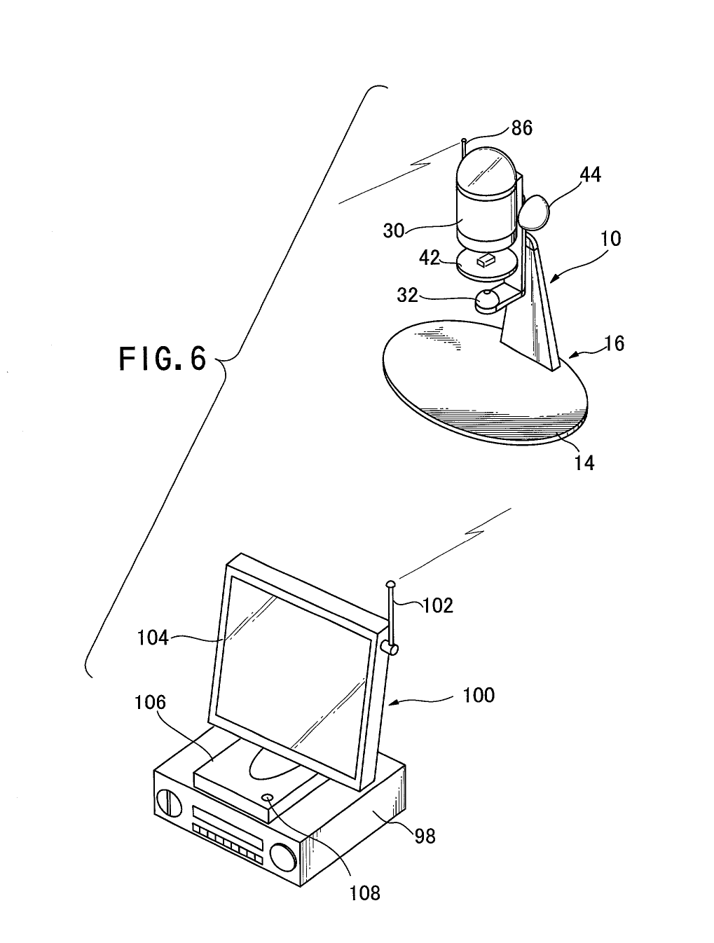

FIG. 7 is a diagram illustrating an exemplary arrangement of an astronomical telescope televising camera system according to the present invention.

### DETAILED DESCRIPTION OF THE PREFERRED EMBODIMENTS

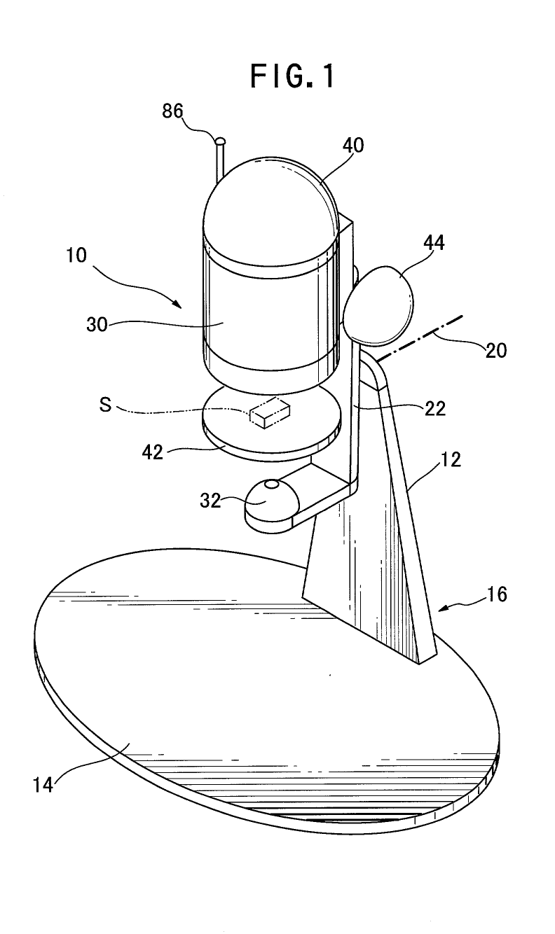

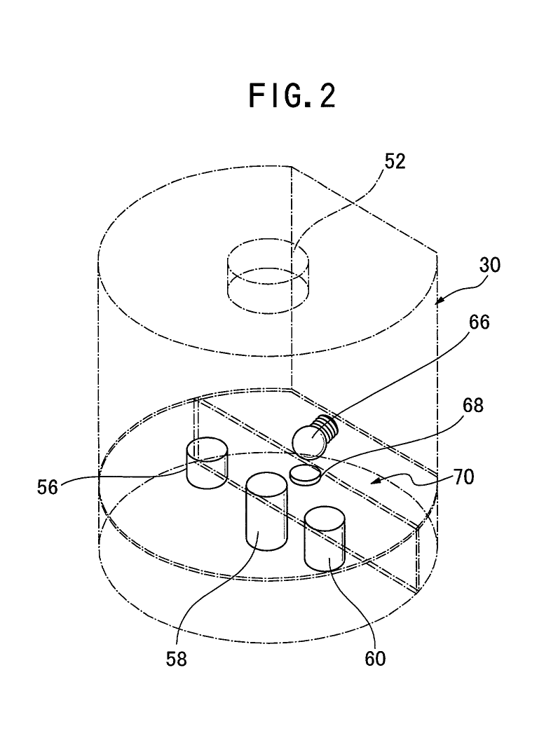

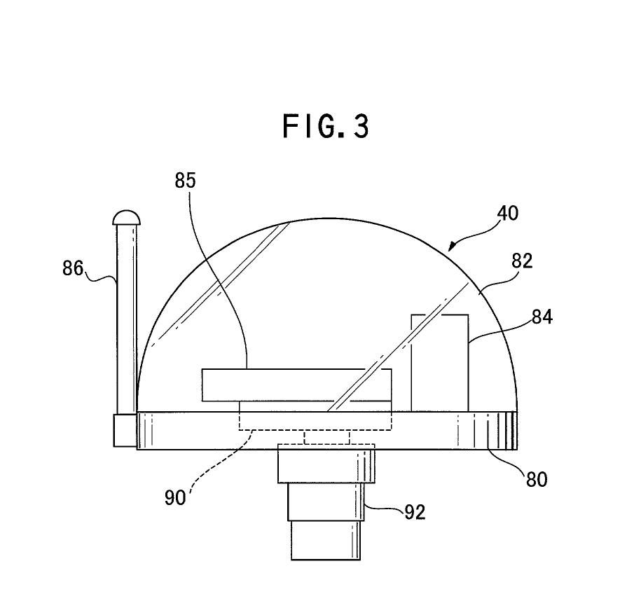

Preferred embodiments of a television microscope according to the present invention will now be described in detail in conjunction with the accompanying drawings. FIG. 1 is a perspective view showing an embodiment of the televising microscope. FIG. 2 is a front view illustrating a microscopic unit in the embodiment of the televising microscope. FIG. 3 is a front view depicting a televising camera unit in the embodiment of the televising microscope.

A televising microscope 10 is, as shown in FIG. 1, comprised of a base 16 consisting of a pillar 12 and a flat plate 14, a supporting arm 22 pivotally fixed about a rotation axis 20 orthogonal to the base 16, microscopic object optics 30 and light transmitting illuminating optics 32 attached respectively to the supporting arm 22, and a wireless televising camera unit 40 located in an imaging position in the microscopic object optics 30.

A sample-mounting plate 42 in which sample S is to reside is fixed along an extension of the rotation axis 20 right ahead of the center of the supporting arm 22. Thus, when the supporting arm 22 rotates, the microscopic object optics 30, the light transmitting illuminating optics 32, and the wireless televising camera unit 40 turn upside down together while the sample-mounting plate 42 remains stationary. The supporting arm 22 has its opposite sides coupled to focusing handles 44 and 46.

As shown in FIG. 2, the microscopic object optics 30 has a roughly cylindrical housing 50 provided in its upper surface with an image transmitting port 52 to which a wireless televising camera unit 40 and an ocular (not shown) are to be attached. Within the housing 50, a plurality of object lenses 56, 58 and 60, which are slidably replaced with each other, are disposed. In an area close to the pillar 12, opposed to the object lenses 56, 58, 60 within the housing, an epi-illuminating optics 70 consisting of a light source (lamp) 66 and a converging lens 68 is positioned.

As can be seen in FIG. 3, the wireless televising camera unit 40 is shaped into an approximately semi-spherical contour and has a flat bottom 80 and a spherical upper half 82 made of transparent resin, and a telescopic transmitter antenna 86 extends from an outer circumpherential edge of the bottom 80. Within the wireless televising camera unit 40, an electric cell 84, a televising radio generator 86, and a light receiving device 90 which may be a CMOS image sensor or a CCD image sensor are disposed. A camera unit mount 92, which is engaged with the image transmitting port 52 of the microscopic object optics 30, is fixed to a lower surface of the bottom 80 at its center.

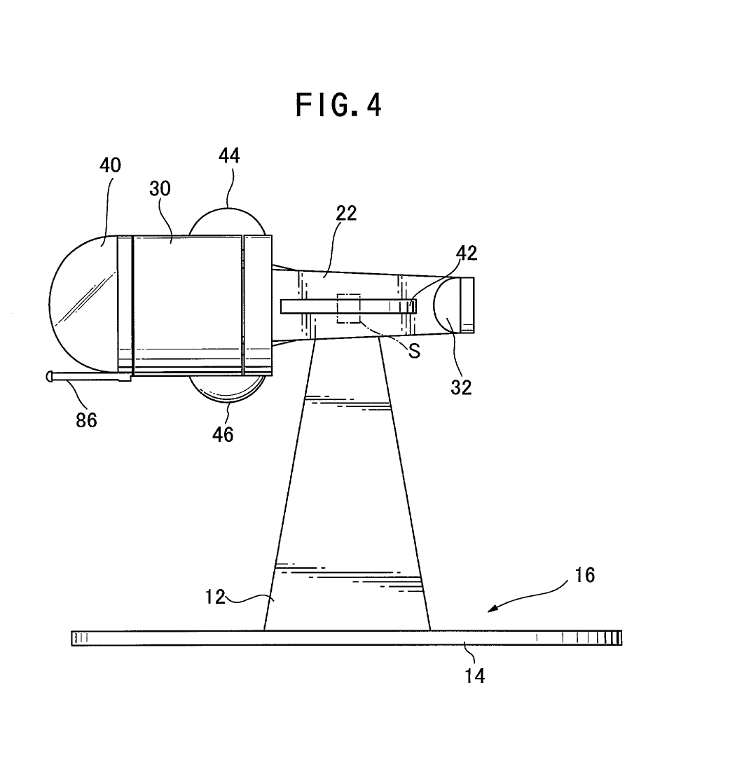

The supporting arm 22 to which the microscopic object optics 30, the illuminating optics 32, and the wireless radio camera unit 40 are affixed can be rotated about a shaft (not shown) corresponding to the rotation axis 20, and as shown in FIG. 4, the illuminating optics 32 illuminates the sample horizontally for subsequent observation. For the observation under adequate conditions, the sample S and the sample-mounting plate 42 are configured so that light flux can be transmitted horizontally through them. This way of observation is advantageously applied to a sample such as aquatic animals so as to facilitate the observation of lateral phases of the animals in their easiest postures.

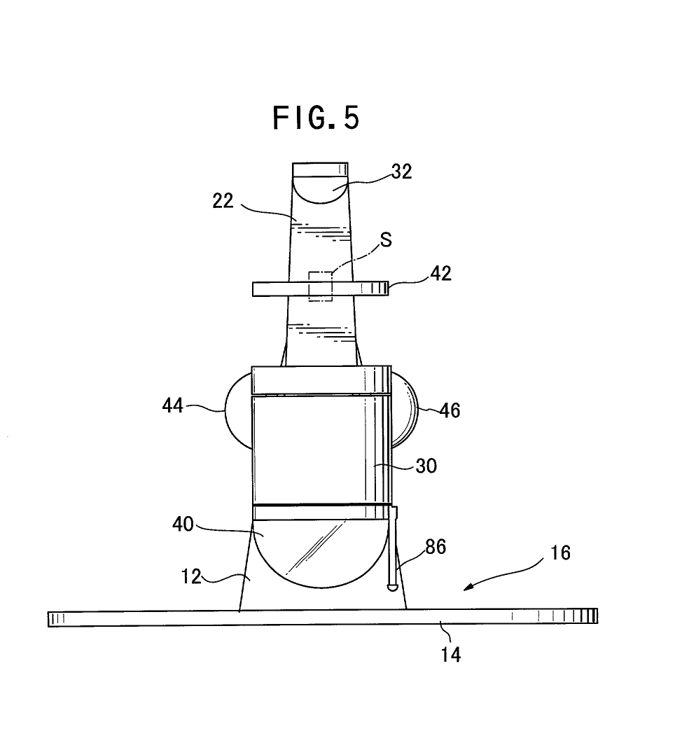

The supporting arm 22 to which the microscopic object optics 30, the illuminating optics 32, and the wireless televising camera unit 40 are affixed is further rotated about the shaft (not shown) corresponding to the rotation axis 20, and as shown in FIG. 5, the illuminating optics 32 illuminates the sample from a vertical position under the sample for subsequent observation. For the observation in adequate conditions, the sample S and the sample-mounting plate 42 are configured so that light flux can be transmitted vertically through them. This way of observation from the position vertically under a sample is advantageously applied to the sample such as aquatic animals so as to facilitate the observation of bottom phases of the animals in their easiest postures, including presence and appearances of their legs and tails.

The televising microscope 10 is combined with a display device 100 such as a liquid crystal display, a portable TV set, a TV set with VCR 98 and the like. The display device 100 is provided with a receiver antenna 102 receiving image signals from the transmitter antenna 86 of the televising microscope 10, a liquid crystal display unit 104, a base 106, and a power switch 108, and it displays transmitted images and records them into video tape and cassette.

The televising microscope 10 is located in an environment convenient for the sample S and suitable for observation of the sample S including desktop, outdoor, temperature control room, magnetic field control room, radiation room, and the like, while the display device 100 is located in a lecture room or a test and administration room, close to or remote from the televising microscope 1.

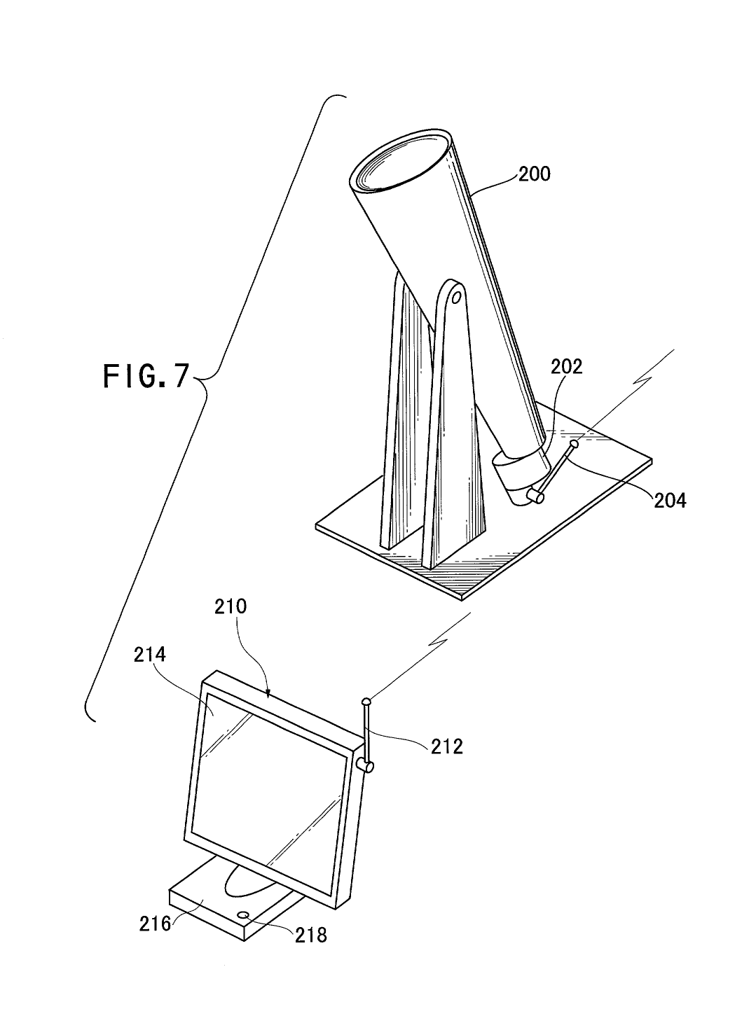

Another preferred embodiment of the present invention is an astronomical telescope televising system, and as shown in FIG. 7, the system is comprised of telescopic object optics 200, a televising camera unit 202, and a display device 210. An ocular optics of the telescope is removed and is replaced with the televising camera unit 202 having a photoelectric device (not shown) sensitive to relatively low level of illuminance, which instead is attached to the telescopic object optics 200. The display device 210 is provided with a receiver antenna 212 receiving image signals from a transmitter antenna 204 of the televising camera unit 202, a liquid crystal display unit 214, a base 216, and a power switch 218.

Although the prior art telescope forces an observer to speculate images inverted in both lateral and vertical directions, the embodiment according to the present invention facilitates to invert images upside down and left to right to get erect images, and this provides significantly advantageous effects of letting the observer know and specify four right phases of celestial bodies in lateral and vertical directions even when the observer is not facing the real celestial bodies.

In this embodiment, any person skilled in the art will easily evaluate that the telescopic object optics can be replaced with appropriate objective optics for terrestrial telescopes and monocles.

In the televising camera apparatus according to the present invention, especially in the televising microscope and the televising microscopic system, there is no cable-connection between microscopic unit and the observing unit or the monitor unit which may restricts relative position of the microscopic unit to the monitor unit, and this advantageously permits indoor observation of samples such as snow as they would be in their respective natural environments.

Also, a simplified configuration of the televising camera apparatus according to the present invention without a rotating sample-mount plate advantageously allows the observer to monitor samples from desired positions when the samples assume orientations varied from one side to another as in a minute identification mark labeled for discriminating authenticated paper currencies and securities from counterfeit ones because of its inconspicuous and incomprehensible geometrical profile when seen from only a single fixed position.

The televising microscope and the televising microscopic system according to the present invention further advantageously allow the observer to monitor samples such as aquatic animals from varied positions, especially from a position under the samples, when it is preferable that the samples are monitored as they would be in their respective natural aquatic environments.

In the televising camera apparatus according to the present invention, especially in the context of the astronomical telescope, the ocular is removed and replaced with the televising camera unit, so as to produce photoelectrically converted image signals in conditions of desired surrounding brightness and dust in the air, and thus, the observer in a laboratory or a lecture room can monitor images on the display device therein.

What is claimed is:

1. A televising microscope, comprising a base, a supporting arm pivotally fixed about a rotation axis orthogonal to the base, a sample-mounting plate, microscopic object optics, and illuminating optics attached respectively to the supporting arm, and a wireless televising camera unit located in an imaging position in the microscopic object optics.

2. A televising microscope according to claim 1, wherein the base can be altered in relative position to the rotation axis so as to be horizontal and non-horizontal.

3. A televising microscope according to claim 1, wherein when the supporting arm rotates about the rotation axis, the sample-mounting plate does not rotate while the microscopic object optics and the illuminating optics rotate along with the supporting arm.

4. A televising microscope according to claim 1, wherein the televising microscope has ocular optics substituted for the wireless televising camera unit.

5. A televising microscope according to claim 1, wherein the wireless televising camera unit has a CMOS image sensor.

6. A televising microscope according to claim 1, wherein the wireless televising camera unit has a CCD image sensor.

7. A televising microscope, comprising a base, a supporting arm pivotally fixed about a rotation axis orthogonal to the base, a sample-mounting plate attached to the base, microscopic object optics and illuminating optics attached respectively to the supporting arm, and a wireless televising camera unit located in an imaging position in the microscopic object optics.

8. A televising microscope, comprising a base, a supporting arm pivotally fixed about a rotation axis orthogonal to the base, a sample-mounting plate, microscopic object optics, and illuminating optics attached respectively to the supporting arm, a wireless televising camera unit located in an imaging position in the microscopic object optics, and a display device.

9. A televising microscopic system, comprising a base, a supporting arm pivotally fixed about a rotation axis orthogonal to the base, a sample-mounting plate attached to the base, microscopic object optics and illuminating optics attached respectively to the supporting arm, a wireless televising camera unit located in an imaging position in the microscopic object optics, and a display device.

10. A televising camera apparatus, comprising an object lens barrel holding an object lens, a camera housing detachably fixed to the object lens barrel, a light receiving element located in an imaging position in relation with the object lens within the camera housing, a television radio generator converting and transmitting wireless image signals produced by the light receiving element, and a display device receiving the image signals from the television radio generator and representing images based upon the image signals.
